(19) United States
(12) Patent Application Publication
(10) Pub. No.: US 2010/0157920 A1
(43) Pub. Date: Jun. 24, 2010

(54) APPARATUS AND METHOD OF CHANNEL BANDWIDTH ALLOCATION

(75) Inventors: Dong Joon CHOI, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/581,241

(22) Filed: Oct. 19, 2009

(30) Foreign Application Priority Data
Dec. 22, 2008 (KR) 10-2008-0131038

(51) Int. Cl. H04W 72/04

(52) U.S. Cl. 370/329

(57) ABSTRACT

Provided is an apparatus for a channel bandwidth allocation, the apparatus including: an information sorting unit to receive bandwidth allocation request information, to sort the received bandwidth allocation request information according to a priority, and to transfer any one of the sorted bandwidth allocation request information to a minislot allocation unit; and a calculation unit to apply a multiplier to a number of bytes, and to transfer, to the minislot allocation unit, the bandwidth allocation request information where a number of requested bytes is calculated, when the bandwidth allocation request information is byte-based bandwidth allocation request information, wherein the minislot allocation unit allocates a minislot based on the bandwidth allocation request information and predetermined setting information.

### CROSS-REFERENCE TO RELATED APPLICATION

This application claims the benefit of Korean Patent Application No. 10-2008-0131038, filed on Dec. 22, 2008, in the Korean Intellectual Property Office, the disclosure of which is incorporated herein by reference.

### BACKGROUND

1. Field of the Invention

The present invention relates to an apparatus for a channel bandwidth allocation, and more particularly, to an apparatus and method that may effectively allocate a bandwidth to upstream channels in real time when a single upstream data stream is distributed and thereby is transmitted to a plurality of channels, for a high speed data transmission in a Hybrid Fiber Coax (HFC) network.

2. Description of the Related Art

Currently, a Cable Modem Termination System (CMTS) and a cable modem based on Data-over-Cable Service Interface Specification (DOCSIS) 1.0, 1.1, and 2.0 standards are being widely used to transmit data in a cable network.

According to existing DOCSIS standards, in the case of an upstream transmission, the cable modem may transmit data using only a single radio frequency (RF) channel. In standards prior to the DOCSIS 2.0 standard, the cable modem may transmit using only a single upstream channel. Therefore, many technologies are generally associated with an independent unitary channel allocation and transmission.

A theoretically proposed method may need a large amount of calculations and operations regardless of its excellent efficiency and thus the CMTS may not process the operations in real time.

Accordingly, in a DOCSIS 3.0 standard transmitting upstream data using a plurality of upstream channels, there is a need for a bandwidth allocation method that may consider a bandwidth allocation status between channels so that a plurality of cable moderns may effectively transmit the upstream data using the plurality of upstream channels.

### SUMMARY

According to an aspect of the present invention, there is provided an apparatus for a channel bandwidth allocation, the apparatus including: an information sorting unit to receive bandwidth allocation request information, to sort the received bandwidth allocation request information according to a priority, and to transfer any one of the sorted bandwidth allocation request information to a minislot allocation unit; and a calculation unit to apply a multiplier to a number of bytes, and to transfer, to the minislot allocation unit, the bandwidth allocation request information where a number of requested bytes is calculated, when the bandwidth allocation request information is byte-based bandwidth allocation request information. The minislot allocation unit may allocate a minislot based on the bandwidth allocation request information and predetermined setting information.

The channel bandwidth allocation apparatus may further include a setting unit to set the setting information as a real-time bandwidth allocation parameter that is calculated based on user command information and at least one Upstream Channel Description (UCD) information parameter for each upstream channel.

Also, the channel bandwidth allocation apparatus may further include: a bandwidth allocation request information processor to generate an interval element (IE) regarding the bandwidth allocation request information that is processed for each channel and is stored in a queue by the minislot allocation unit, and to store the IE in an IE table; and a MAP message generator to generate and output a MAP message associated with at least one channel by referring to the IE table.

According to another aspect of the present invention, there is provided a method for a channel bandwidth allocation, the method including: receiving bandwidth allocation request information to sort the received bandwidth allocation request information according to a priority, and to transfer any one of the sorted bandwidth allocation request information to a minislot allocation unit; applying a multiplier to a number of bytes to transfer, to the minislot allocation unit, the bandwidth allocation request information where a number of requested bytes is calculated, when the bandwidth allocation request information is byte-based bandwidth allocation request information; and allocating a minislot based on the bandwidth allocation request information and predetermined setting information.

According to still another aspect of the present invention, there is provided a method for a channel bandwidth allocation, the method including: determining whether a period is a MAP output period; determining whether another bandwidth allocation request information is received, when the period is not the MAP output period; applying a multiplier to a number of bytes to output the other bandwidth allocation request information where a number of requested bytes is calculated, when the other bandwidth allocation request information is received; determining whether a minislot length of a minislot allocated by a previous Interval Usage Code (IUC) allocation scheme exceeds an IUC period in at least one upstream channel; allocating and outputting an IUC interval with respect to a channel where the minislot length exceeds the IUC period; determining whether a number of minislots exceeds a number of minislots that can be allocated per a single MAP message in the at least one upstream channel; outputting a MAP end primitive about the MAP message exceeding the number of minislots, and outputting a MAP start primitive about another MAP message, when the number of minislots exceeds the number of minislots that can be allocated per the single MAP message; and outputting contention interval bandwidth allocation request interval information when the primitives are output.

In this instance, the method may further include: generating and outputting the MAP message by referring to a stored minislot table, when it is the MAP output period; and outputting the bandwidth allocation request information where a service ID (SID) of an unused interval is allocated, when a bandwidth allocated for the at least one channel disuses an interval about a MAP length.

Also, the applying and the outputting may include: normalizing and comparing minislot values of allocated minislots in the at least one channel; comparing the normalized minislot values; allocating a first allocation bandwidth to an available channel between an early point in time and a late point in time; allocating a second allocation bandwidth to an additionally available channel within a service flow transmitting the bandwidth allocation request information, when the first allocation bandwidth is less than a number of bytes requested by a cable modem; and adjusting an allocation bandwidth, when the first allocation bandwidth and the second allocation bandwidth are inseparable with respect to a required bandwidth.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of an upstream and downstream high speed data transmission using channel bonding in a Hybrid Fiber Coax (HFC) network according to an embodiment of the present invention;

FIG. 2 is a diagram illustrating an example of an upstream channel bandwidth allocation based on a Data-over-Cable Service Interface Specification (DOCSIS) 3.0 standard according to an embodiment of the present invention;

FIG. 3 is a block diagram illustrating a configuration of a setting unit included in a channel bandwidth allocation apparatus according to an embodiment of the present invention;

FIG. 4 is a diagram illustrating an example of a minislot table according to an embodiment of the present invention;

FIG. 5 is a diagram illustrating an example of setting a service flow attribute for a multi-channel upstream real-time bandwidth allocation according to an embodiment of the present invention;

FIG. 6 is a diagram illustrating an example of bandwidth allocation request information packet according to an embodiment of the present invention;

FIG. 7 is a block diagram illustrating a configuration of a channel bandwidth allocation apparatus according to an embodiment of the present invention;

FIG. 8 is a flowchart illustrating a method for a channel bandwidth allocation according to an embodiment of the present invention;

FIG. 9 is a diagram illustrating an example of a byte-based bandwidth allocation request processing form according to an embodiment of the present invention;

FIG. 10 is a flowchart illustrating a method of processing byte-based bandwidth allocation request information according to an embodiment of the present invention;

FIG. 11 is a diagram illustrating an example of an output format of a bandwidth allocation request information packet for each allocated channel according to an embodiment of the present invention; and

FIG. 12 is a block diagram illustrating a configuration of a per-channel MAP message generator according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may render the purpose of the present invention unnecessarily ambiguous in describing the present invention, the detailed description will be omitted here. Also, terms used herein are defined to appropriately describe the exemplary embodiments of the present invention and thus may be changed depending on a user, the intent of a user, or a custom. Accordingly, the terms must be defined based on the following overall description of this specification.

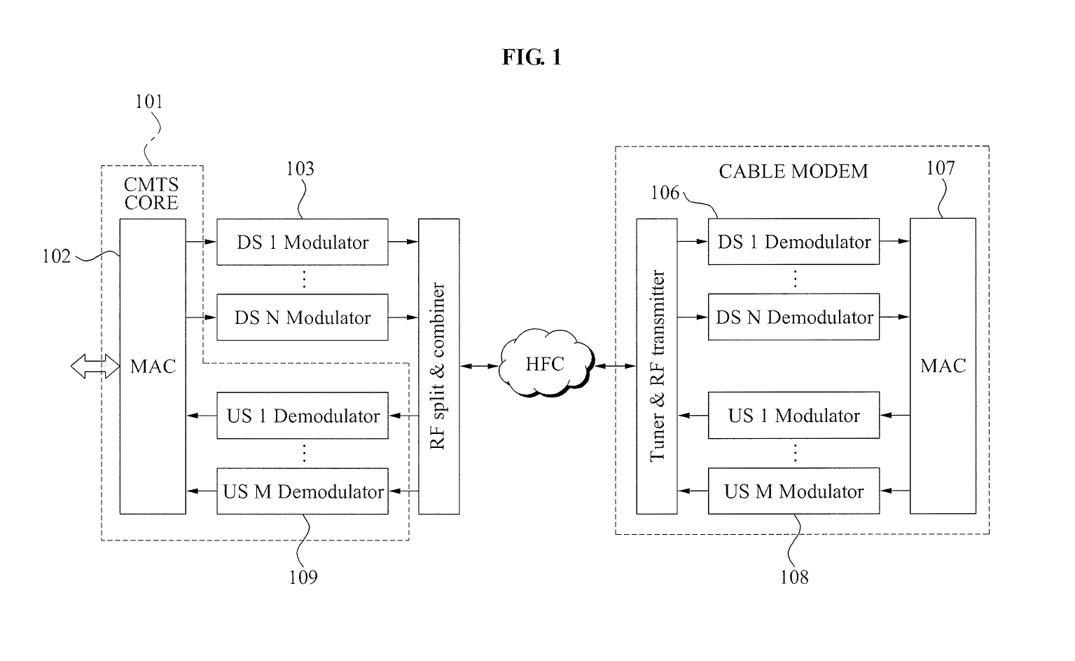

FIG. 1 is a diagram illustrating an example of an upstream and downstream high speed data transmission using channel bonding in a Hybrid Fiber Coax (HFC) network according to an embodiment of the present invention.

According to an embodiment of the present invention, when a channel bandwidth allocation apparatus desires to distribute and thereby transmit a single data stream for a high speed data transmission in an HFC network, the channel bandwidth allocation apparatus may effectively allocate a bandwidth to upstream channels.

According to an embodiment of the present invention, it is possible to provide a high speed upstream MAC processing technology in a next generation cable network capable of performing a multi-channel upstream real-time bandwidth allocation so that a plurality of cable modems may effectively transmit data using a plurality of upstream channels in a Cable Modem Termination System (CMTS) according to an upstream channel transmission form defined in a Data-over-Cable Service Interface Specification (DOCSIS) 3.0 standard.

Referring to FIG. 1, in channel bonding according to an embodiment of the present invention, a transmission side may divide data input into Media Access Control (MAC) layers 102 and 107 with respect to physical channels, for example, modulators 103 and 108, and thereby transmit the divided data to other physical layers, for example, demodulators 106 and 109. A reception end may sequentially restore the data that is transmitted to the demodulators 106 and 109, in the MAC layers 102 and 107, to thereby receive the data.

In the case of a downstream transmission, high speed data input from a backbone network or a server may be distributed and be transmitted from the MAC layer 102 of a CMTS core 101 to the modulators 103. A signal demodulated in each corresponding radio frequency (RF) channel using a cable modem may be restored in the MAC layer 107 and be transmitted to a Customer Premises Equipment (CPE).

In the case of an upstream transmission, the MAC layer 107 may transmit data using the modulators 108, which is similar to the downstream transmission. However, in the upstream transmission, a plurality of cable modems may temporally divide and share a single frequency band to transmit data to a CMTS.

Accordingly, an upstream channel bandwidth allocation method based on a DOCSIS 3.0 standard according to an embodiment of the present invention will be described.

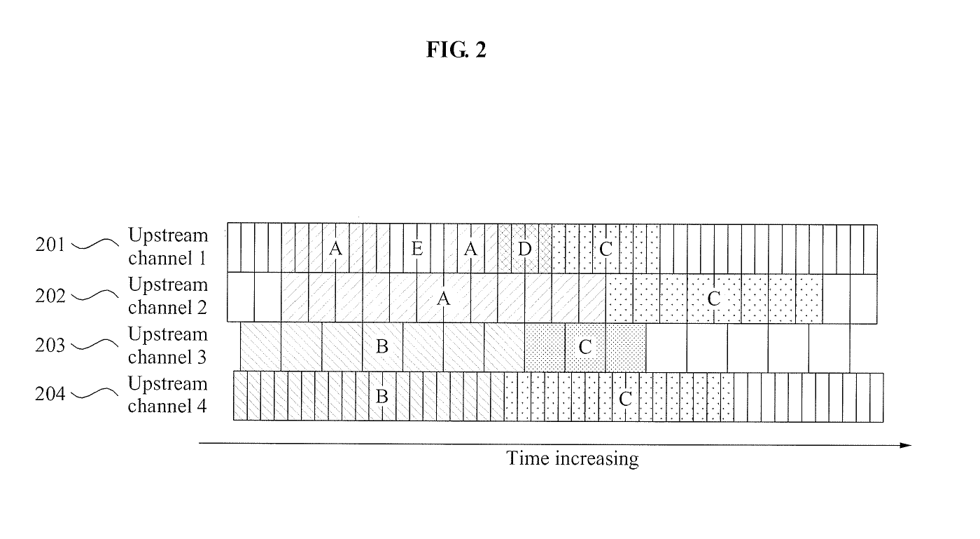

FIG. 2 is a diagram illustrating an example of an upstream channel bandwidth allocation based on a DOCSIS 3.0 standard according to an embodiment of the present invention.

Referring to FIG. 2, the DOCSIS 3.0 standard may allocate upstream channels (1, 2, 3, and 4) 201, 202, 203, and 204 with respect to different cable modems A, B, C, and D.

Here, each of the upstream channels (1, 2, 3, and 4) 201, 202, 203, and 204 may use a different upstream channel transmission parameter, for example, may use a different modulation scheme, a channel coding scheme, a minislot length, and the like. Start points in time of minislots may not be synchronized.

Also, according to an embodiment of the present invention, when transmitting upstream data in an HFC network according to a DOCSIS 3.0 standard, a plurality of cable modems may temporally divide and use the same frequency band. When a random cable modem desires to transmit data in the HFC network, a CMTS may temporally divide a slot with respect to an operating upstream bandwidth, and transmit MAP information regarding which time slot the corresponding cable modem may use. The cable modem may transmit a required amount of data in the allocated time slot.

Also, according to an embodiment of the present invention, in a DOCSIS 3.0 standard, in the case of an upstream transmission, when a cable modem transmits a transmission data amount to a CMTS as a request message, the CMTS may allocate a bandwidth with respect to a plurality of upstream channels set by the cable modem during an initial registration process. For example, in FIG. 2, a cable modem may use the upstream channels (1 and 2) 201 and 202, and transmit data in intervals indicated by “A”.

According to an embodiment of the present invention, a user may set setting information with respect to an initial channel bandwidth allocation apparatus, and control a bandwidth to be allocated based on the setting information.

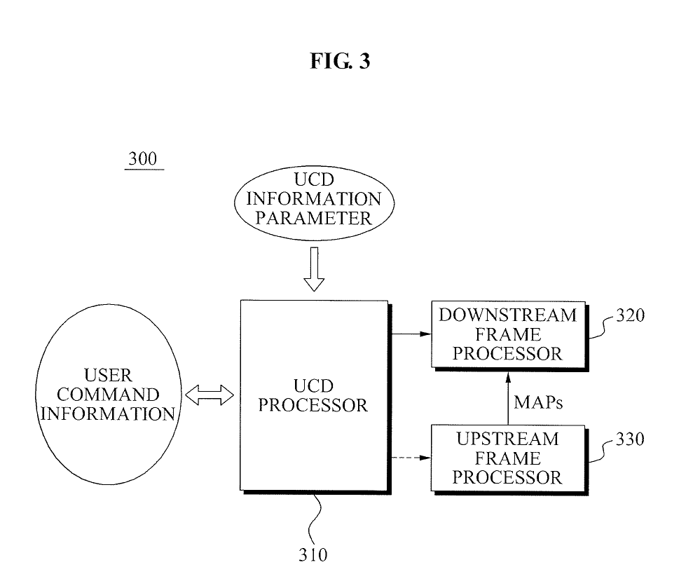

FIG. 3 is a block diagram illustrating a configuration of a setting unit 300 included in a channel bandwidth allocation apparatus according to an embodiment of the present invention.

As shown in FIG. 3, the channel bandwidth allocation apparatus may include the setting unit 300 to set setting information as a real-time bandwidth allocation parameter that is calculated based on user command information and at least one Upstream Channel Description (UCD) information parameter for each upstream channel. A user may set how to perform a channel bandwidth allocation using the setting unit 300.

The setting unit 300 may include a UCD processor 310 to receive the user command information and the at least one UCD information parameter for each upstream channel; a downstream frame processor 320 to output per-channel UCD information that is generated based on the user command information and the at least one UCD information parameter; and an upstream frame processor 330 to calculate the at least one UCD information parameter using a real-time bandwidth allocation available parameter, and to set the setting information using the calculated parameter.

The UCD processor 310 may receive the user command information and the at least one UCD message parameter to generate per-channel UCD message and to output the generated per-channel UCD message using the downstream frame processor 320. Through a calculation process of generating each parameter as a new parameter suitable for the real-time upstream bandwidth allocation, the generated parameter may be set as setting information in a real-time bandwidth allocation processor (not shown) of the upstream frame processor 330.

For example, the at least one UCD information parameter received for the real-time upstream channel bandwidth allocation may include an Upstream Channel ID (UCID), a UCD change count, a minislot size, a single MAP time, a channel transmission rate, a maximum number of requests for a contention interval, a maximum cable modem distance, an initial ranging interval length, and the like.

Also, a burst parameter used for each channel may be input as the UCD information parameter. For example, the burst parameter may include a Forward Error Control (FEC) message length, a maximum burst size, a guard time, a preamble length, and the like.

The parameter for the real-time bandwidth allocation may be calculated using the input UCD information parameter. The calculated parameter may be set as the setting information in a storage unit of the real-time bandwidth allocation processing unit of the upstream frame processor 330.

A new value calculated as the parameter for the real-time bandwidth allocation may include, for example, a minislot length for each MAP in a channel n (A_MAP_Minislot(n)), a IUC1 interval minislot length in the channel n (IUC1_interval_MiniSlot(n)), an initial maintenance interval minislot length in the channel n (InitialMaintenanceInterval_Minislot(n), an IUC1 burst minislot length in the channel n (IUC1_Burst_MiniSlot(n)), an IUC3 burst minislot length in the channel n (IUC3_Burst_MiniSlot(n)), an IUC4 burst minislot length in the channel n (IUC4_Burst_MiniSlot(n)), and the like.

The upstream frame processor 330 may store, in a storage unit, a minislot table that is calculated based on the maximum burst size for each channel.

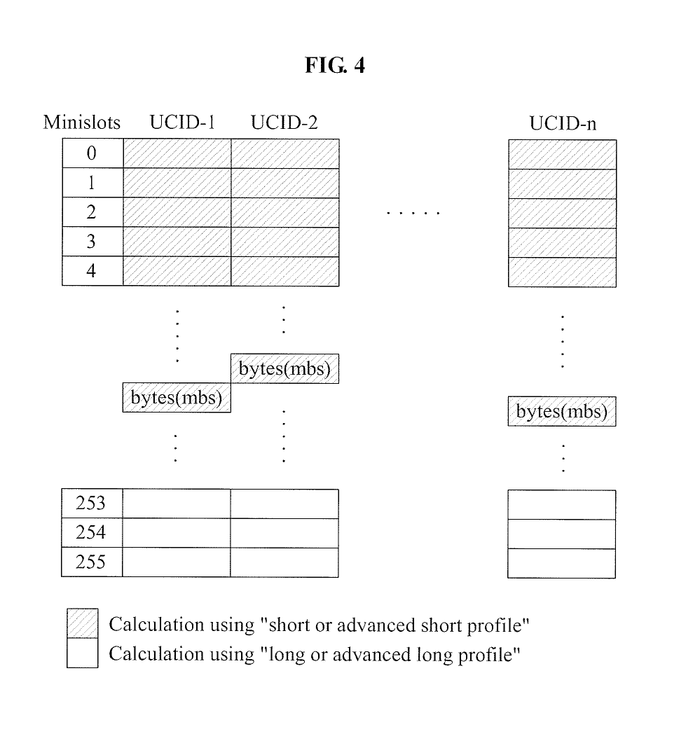

FIG. 4 is a diagram illustrating an example of a minislot table according to an embodiment of the present invention.

As shown in FIG. 4, in each upstream channel, the minislot table may show a number of bytes constituting a DOCSIS MAC packet that may be transmitted using N minislots. Here, a length of a segment header is excluded.

The minislot table may be calculated using “short or advanced short profile” within a UCD message with respect to a number of minislots less than or equal to a maximum burst size by considering the maximum burst size for each channel. The minislot table may be calculated using “long or advanced long file” within the UCD message with respect to the number of slots greater than the maximum burst size.

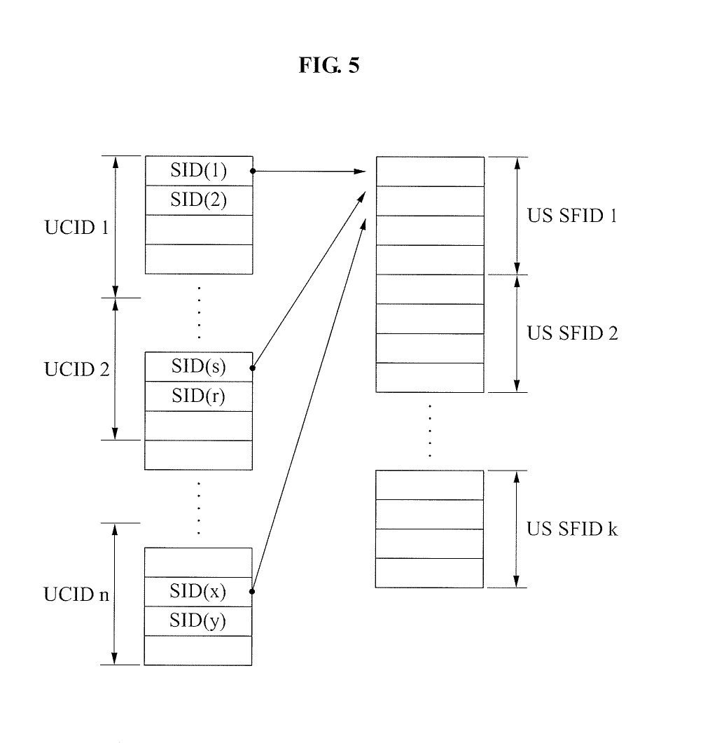

FIG. 5 is a diagram illustrating an example of setting a service flow attribute for a multi-channel upstream real-time bandwidth allocation according to an embodiment of the present invention.

An upstream service flow attribute may include various types of parameters associated with a Quality of Service (QoS), for example, a priority associated with a multi-channel real-time upstream bandwidth allocation, a service flow type, a request transmission (RT) policy, a multiplier to a number of bytes, a service ID (SID) cluster, and the like. The upstream service flow attribute may be stored in a storage unit of the upstream bandwidth allocation processor and be referred to at all times.

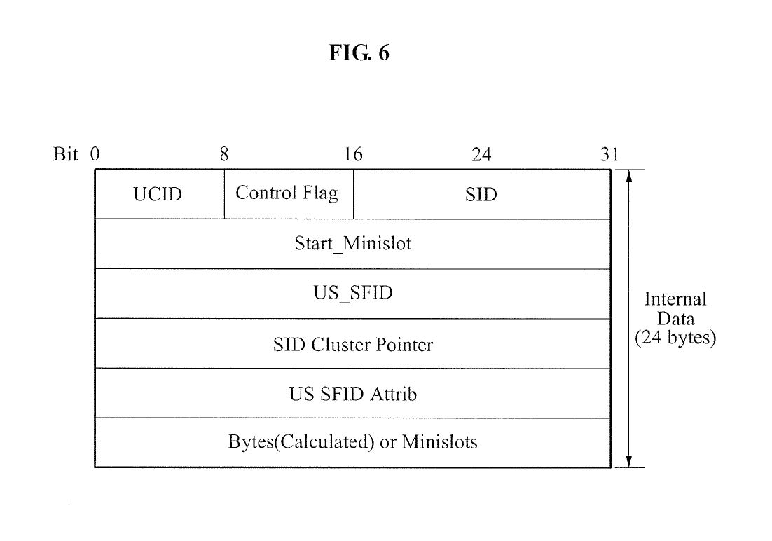

FIG. 6 is a diagram illustrating an example of bandwidth allocation request information packet according to an embodiment of the present invention.

As shown in FIG. 6, the bandwidth allocation request information may be generated by processing information that is included in an extension header of a unicast frame or a bandwidth allocation request frame received in a contention interval from a cable modern.

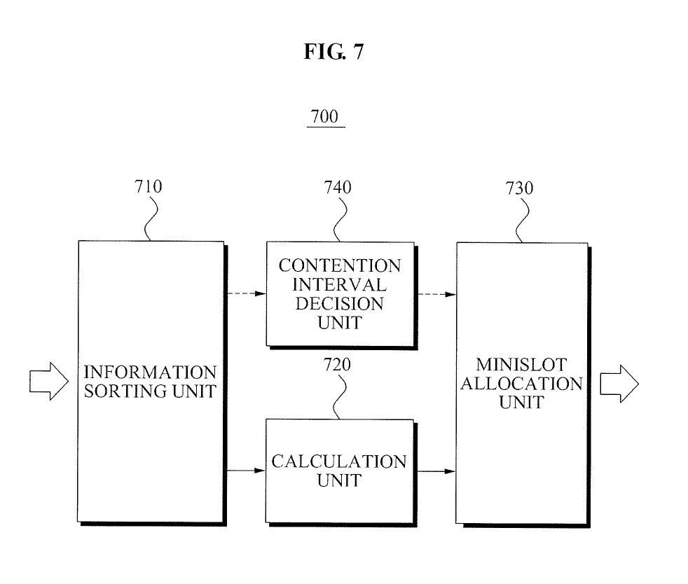

A setting method of the channel bandwidth allocation apparatus according to an embodiment of the present invention has been described above. Hereinafter, a method of receiving bandwidth allocation request information to allocate a channel bandwidth in the above setting status will be described with reference to FIG. 7.

FIG. 7 is a block diagram illustrating a configuration of a channel bandwidth allocation apparatus 700 according to an embodiment of the present invention.

The channel bandwidth allocation apparatus 700 may include an information sorting unit 710, a calculation unit 720, and a minislot allocation unit 730. Here, the information sorting unit 710 may receive bandwidth allocation request information to sort the received bandwidth allocation request information according to a priority, and may transfer any one of the sorted bandwidth allocation request information to the minislot allocation unit 730. When the bandwidth allocation request information is byte-based bandwidth allocation request information, the calculation unit 720 may apply a multiplier to a number of bytes and transfer, to the minislot allocation unit 730, the bandwidth allocation request information where a number of requested bytes is calculated. The minislot allocation unit 730 may allocate a minislot based on the bandwidth allocation request information and predetermined setting information.

The information sorting unit 710 may multiplex the sorted bandwidth allocation request information to transfer any one of the multiplexed bandwidth allocation request information to the minislot allocation unit 730.

The bandwidth allocation request information received by the information sorting unit 710 may include at least one of unicast ranging information, information generated in a request frame form of a contention interval, information input in a piggyback form of a non-segment service flow, information input in a piggyback form of a segment service flow, and reserved information. The above information may be separated and be stored.

The channel bandwidth allocation apparatus 700 may further include a contention interval decision unit 740 to receive form recognition information from the information sorting unit 710, and to transfer the form recognition information to the minislot allocation unit 730, when the output bandwidth allocation request information is in the request frame form of the contention interval.

Also, when the bandwidth allocation request information is based on minislots, the channel bandwidth allocation apparatus 700 may output the bandwidth allocation request information to the minislot allocation unit 730 without a separate process for the bandwidth allocation request information. When the bandwidth allocation request information is based on bytes, the minislot allocation unit 730 may apply the multiplier to the number of bytes of a corresponding service flow to thereby calculate and output the number of requested bytes.

The minislot allocation unit 730 may allocate and output minislots required for upstream channels, by referring to a minislot table where the sequentially input bandwidth allocation request information and real-time parameters are stored.

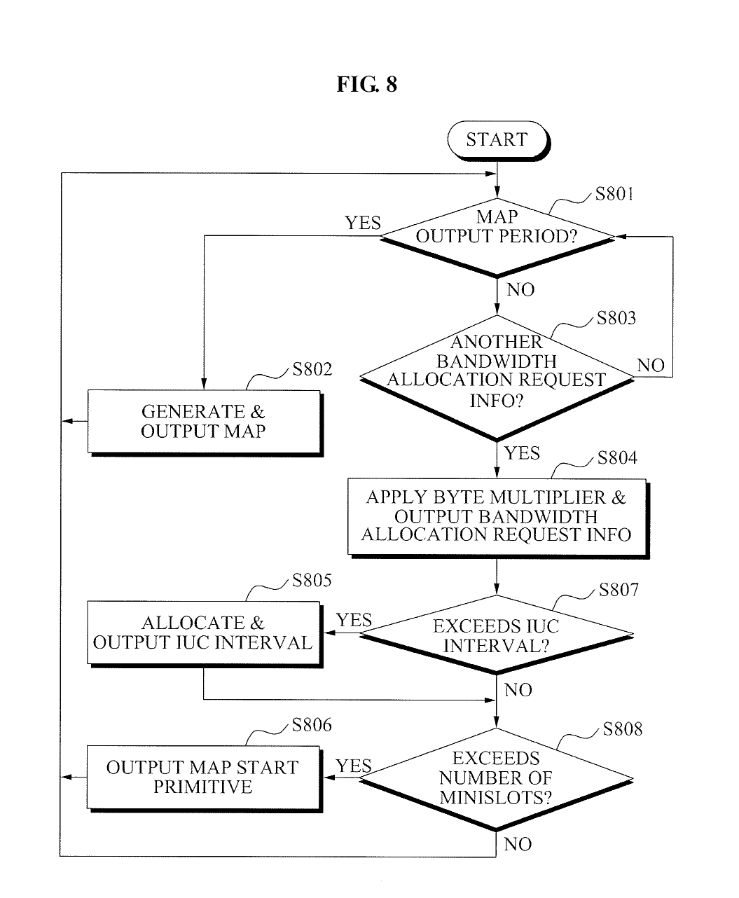

Hereinafter, a method for a channel bandwidth allocation according to an embodiment of the present invention will be described in detail with reference to FIG. 8.

FIG. 8 is a flowchart illustrating a method for a channel bandwidth allocation according to an embodiment of the present invention.

In operation S801, the channel bandwidth allocation apparatus 700 may determine whether it is a MAP output period.

In operation S802, when the MAP output period has not expired, the channel bandwidth allocation apparatus 700 may generate and output a MAP message by referring to a minislot table.

When a bandwidth allocated for at least one channel disuses an interval for a MAP length, the channel bandwidth allocation apparatus 700 may control the bandwidth allocation request information where an assigned SID, for example, SID 0 within an unused interval is outputted.

When it is not the MAP output, the channel bandwidth allocation apparatus 700 may determine whether another bandwidth allocation request information, that is, new bandwidth allocation request information is received.

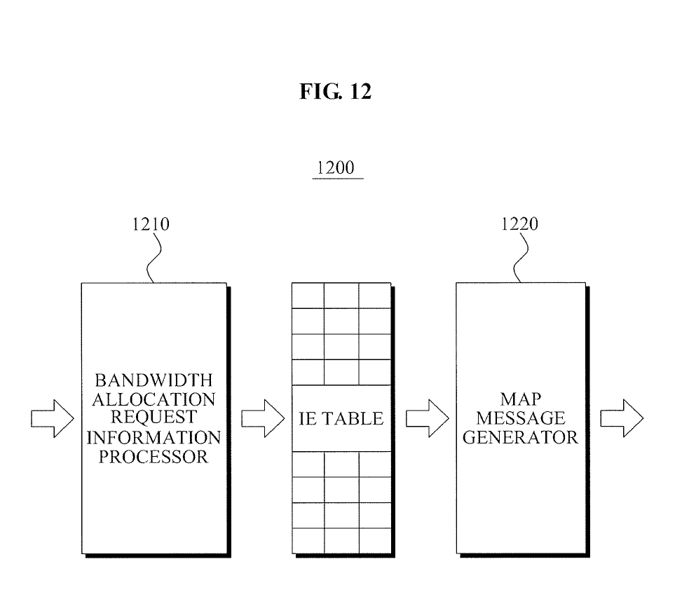

When the other bandwidth allocation request information is received, the channel bandwidth allocation apparatus 700 may apply a multiplier to a number of bytes to output the other bandwidth allocation request information where a number of requested bytes is calculated in operation S804. Specifically, when byte-based bandwidth allocation request information is received as the other bandwidth allocation request information, the channel bandwidth allocation apparatus 700 may calculate the number of requested bytes using the calculation unit 720 to output the bandwidth allocation request information in operation S804. Operation S804 will be described again later with reference to FIG. 12.

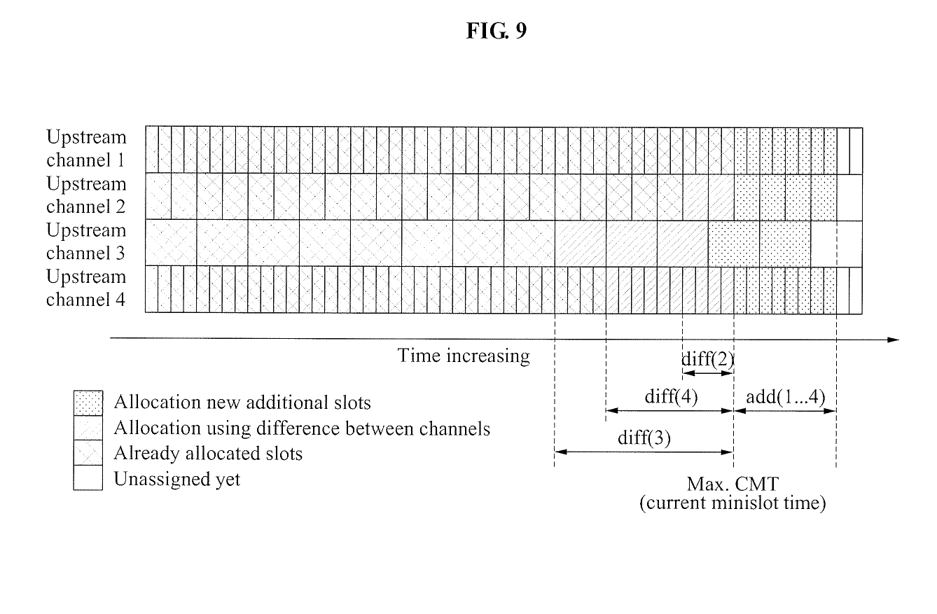

The byte-based bandwidth allocation request information may be processed through the following two operations, which will be described with reference to FIG. 9.

FIG. 9 is a diagram illustrating an example of a byte-based bandwidth allocation request processing form according to an embodiment of the present invention.

First, with respect to transmittable upstream channels of a service flow including bandwidth allocation request information, absolute times of currently allocated minislots may be compared. A bandwidth may be allocated in advance with respect to a difference therebetween.

For the above bandwidth allocation, upstream channels 1, 2, 3, and 4 may have a different minislot size. For the above comparison, there is a need for a normalization process to express the minislot size in a single scale. When normalized minislot values are compared, a relatively large number of bandwidths are allocated to the upstream channel 1 in comparison to the other upstream channels 2, 3, and 4. Also, diff(2), diff(3), and diff(4) may indicate an absolute difference of the minislot size with the upstream channel 1.

Therefore, according to an embodiment of the present invention, the channel bandwidth allocation apparatus 700 may allocate, in advance, a bandwidth to the upstream channel 3 with a relatively small absolute value of the minislot with respect to the byte-based bandwidth allocation request information. When an additional bandwidth is required, the channel bandwidth allocation apparatus 700 may allocate the additional bandwidth in an order of the upstream channel 4 and the upstream channel 2.

Second, when the allocated bandwidth does not satisfy the number of requested bytes due to the minislot difference, an additional minislot may be allocated to a transmittable upstream channel in a corresponding service flow. When the additional minislot is allocated to the transmittable upstream channel, the additional minislot may be allocated so that an end of an allocated interval may have a smallest value.

Also, operation S804 may be performed through the following process.

In operation S804, the channel bandwidth allocation apparatus 700 may perform requesting a unicast ranging bandwidth allocation, requesting an unprocessed bandwidth allocation, requesting a bandwidth allocation using a request frame, and the bandwidth allocation using a piggyback form.

In operation S807, the channel bandwidth allocation apparatus 700 may determine whether a minislot length of a minislot allocated by a previous Interval Usage Code (IUC) allocation scheme exceeds an IUC period in at least one upstream channel.

When the length of the minislot exceeds the IUC period, the channel bandwidth allocation apparatus 700 may allocate and output an IUC interval with respect to a channel exceeding the IUC period in operation S805.

In operation S808, the channel bandwidth allocation 700 may determine whether a number of minislots exceeds a number of minislots that may be allocated for a single MAP message in the at least one upstream channel.

When the number of minislots exceeds the number of minislots that may be allocated for the single MAP message, the channel bandwidth allocation 700 may output a MAP end primitive about the MAP message exceeding the number of minislots and output a MAP start primitive about another MAP message in operation S806.

When the primitives are output, the channel bandwidth allocation 700 may output contention interval bandwidth allocation request interval information.

According to an embodiment of the present invention, when there is a need for processing the byte-based bandwidth allocation request information, corresponding bandwidth allocation request information may be processed by the following process.

Initially, the channel bandwidth allocation apparatus 700 may normalize and compare minislot values of allocated minislots in the at least one channel.

The channel bandwidth allocation apparatus 700 may compare the normalized minislot values and allocate a first allocation bandwidth to an available channel between an early point in time and a late point in time.

When the first allocation bandwidth is less than a number of bytes requested by a cable modem, the channel bandwidth allocation apparatus 700 may allocate a second allocation bandwidth to an additionally available channel within a service flow transmitting the upstream bandwidth allocation request information.

When the first allocation bandwidth and the second allocation bandwidth are inseparable with respect to a required bandwidth, the channel bandwidth allocation apparatus 700 may adjust an allocation bandwidth.

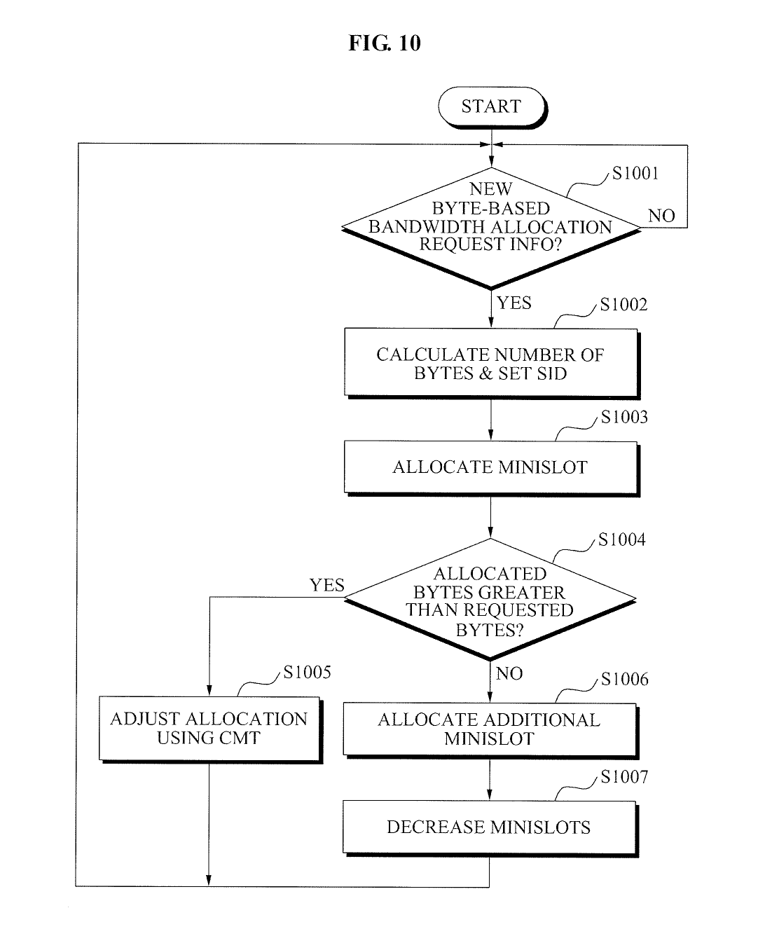

A method of processing byte-based bandwidth allocation request information according to an embodiment of the present invention will be described in detail with reference to FIG. 10.

FIG. 10 is a flowchart illustrating a method of processing byte-based bandwidth allocation request information according to an embodiment of the present invention.

In operation S1001, the channel bandwidth allocation apparatus 700 may determine whether bandwidth allocation request information corresponding to byte-based bandwidth allocation request information exists.

When the byte-based bandwidth allocation request information exists, the channel bandwidth allocation apparatus 700 may calculate a number of requested bytes by applying a byte multiplier of a corresponding service flow, and search for a SID cluster including the bandwidth allocation request information to set a SID of a transmittable channel in operation S1002.

In operation S1003, the channel bandwidth allocation apparatus 700 may compare normalized minislot values to allocate a first bandwidth allocation bandwidth to an available channel between an early point in time and a late point in time, that is, allocate a single minislot based on an allocated minislot value.

Here, operation S1003 may be performed according to the following Equation 1 and Equation 2:

NCMT(n)=CMT(n)×2^{M(n)}, M(n)=0, . . . , 7 diff_{—}NCMT(n)=max_{—}CMT−NCMT(n) [Equation 1]

where CMT(n) denotes a currently allocated minislot value with respect to an available upstream channel n, NCMT(n) denotes a normalized minislot value with respect to CMT(n), max_NCMT denotes a maximum value among the normalized minislot values, diff_NCMT(n) denotes a difference with the maximum value, n denotes a transmittable upstream channel, and M(n) denotes a minislot size in the upstream channel n, and

$$alloc\_mslot ( n ) = \frac{diff\_NCMT ( n )}{{2}^{M ( n )}} \\ alloc\_bytes ( n ) = byte\_lookup ( n , alloc\_mslot ( n ) ) \\ alloc\_bytes \_sum = {\sum }_{AvailableChannels} byte\_lookup ( n , alloc\_byte ( n ) ) , \qquad [ Equation 2 ]$$

where alloc_mslot(n) denotes a number of minislots allocated with respect to transmittable upstream channels according to a request for byte-based bandwidth allocation request information, alloc_byte(n) denotes a number of bytes that are transmittable to each allocated minislot of each channel, alloc_bytes_sum denotes a total number of bytes, and byte_lookup(n, s) denotes a number of bytes that are transmittable to s minislots with respect to the upstream channel n.

In operation S1004, the channel bandwidth allocation apparatus 700 may determine whether a number of bytes transmittable to a minislot allocated for the first allocation bandwidth is greater than a number of bytes associated with the bandwidth allocation request information.

In operation S1005, when the number of bytes transmittable to the minislot allocated for the first allocation bandwidth is greater than the number of bytes requested for a bandwidth allocation, the channel bandwidth allocation apparatus 700 may reallocate the first allocation bandwidth according to the following Equation 3:

$$K = \frac{alloc\_bytes \_sum}{X} \\ min\_offset \_CMT = \frac{max\_NCMT - min\_NCMT}{K} \\ upper\_NCMT = min\_NCMT + min\_offset \_NCMT \\ alloc\_mslot ( n ) = \frac{upper\_NCMT - NCMT ( n )}{{2}^{M ( n ) }} , \qquad [ Equation 3 ]$$

where min_NCMT denotes a minimum value among the normalized minislot values, upper_NCMT denotes an upper reference value with respect to the normalized minislot values, X denotes a number of bytes required for the bandwidth allocation, and basic_bytes_ a set denotes a number of bytes that are transmittable using the minislot in the transmittable channel.

Also, after newly obtaining alloc_bytes_sum, when alloc_bytes_sum is greater than a sum of X and basic_bytes_a_set, the channel bandwidth allocation apparatus 700 may set max_NCMT to upper_NCMT, otherwise, the channel bandwidth allocation apparatus 700 may set min_NCMT to upper_NCMT and recalculate upper_NCMT using (max_CMT+min_CMT)/2.

Also, according to an embodiment of the present invention, the channel bandwidth allocation apparatus 700 may calculate a number of newly allocated slots for each channel according to the above Equation 3, and may repeat the above operation until alloc_bytes_sum calculated according to the above Equation 2 becomes greater than X and less than X+basic_bytes.

In operation S1006, the channel bandwidth allocation apparatus 700 may allocate a second allocation bandwidth.

Also, in operation S1006, the channel bandwidth allocation apparatus 700 may select any one channel from available channels to calculate a relative data transmission rate with respect to the selected channel.

Also, in operation S1006, the channel bandwidth allocation apparatus 700 may calculate a number of first additional minislots with respect to the selected channel and a number of bytes transmittable via the first additional minislots according to the following Equation 4:

$$sel\_bytes = ( X - alloc\_bytes \_sum ) \times \frac{Ratio ( sel\_ch )}{{\sum }_{AvailableChannel} Ratio ( k )} \\ add\_mslot ( sel\_ch ) = Search\_minislot ( sel\_ch , sel\_bytes ) , \qquad [ Equation 4 ]$$

where sel_ch denotes the available channel, Ratio(n) denotes the relative data transmission with respect to the selected channel, add_sel_bytes denotes the number of bytes transmittable via the first additional minislots.

Also, in operation S1006, the channel bandwidth allocation apparatus 700 may calculate a number of second additional minislots corresponding to the number of first additional minislots with respect to the available channels according to the following Equation 5:

$$add\_mslot ( n ) = add\_mslot ( sel\_ch ) \times \frac{{2}^{M ( sel \_ ch )}}{{2}^{M ( n )}} . \qquad [ Equation 5 ]$$

Also, in operation S1006, the channel bandwidth allocation apparatus 700 may set alloc_mslot(n) of the above Equation 2 and the number of second additional minislots as alloc_mslot(n) using the normalized minislot values.

Also, in operation S1006, the channel bandwidth allocation apparatus 700 may calculate alloc_bytes_sum using the above Equation 2.

Also, in operation S1006, when alloc_bytes_sum is less than X, the channel bandwidth allocation apparatus 700 may additionally allocate a minislot of the second allocation bandwidth until alloc_bytes_sum becomes greater than X with respect to the available channels.

In operation S1007, the channel bandwidth allocation apparatus 700 may adjust the allocation bandwidth.

According to an embodiment of the present invention, in operation S1007, the channel bandwidth allocation apparatus 700 may calculate spare bytes that is a difference value between alloc_bytes_sum and X with respect to the available channels according to the following Equation 6:

$$spare\_mslot = \frac{spare\_bytes}{basic\_bytes \_a \_set} , \qquad [ Equation 6 ]$$

where spare_bytes denotes the spare bytes.

Also, in operation S1007, when alloc_bytes_sum is greater than a sum of X and a number of bytes that are transmittable using a single minislot in the available channel, the channel bandwidth allocation apparatus 700 may decrease the number of minislots to correspond to spare minislots, using the following Equation 7:

$$req\_bytes < alloc\_bytes \_sum < ( \begin{matrix}req\_bytes + \\ basic\_bytes \_a \_set\end{matrix} ) , \qquad [ Equation 7 ]$$

where basic_bytes_a_set denotes the number of bytes that are transmittable using the single minislot in the available channel.

Also, in operation S1007, the channel bandwidth allocation apparatus 700 may calculate alloc_bytes_sum by decreasing the number of minislots with respect to the available channels.

Also, in operation S1007, when alloc_bytes_sum is greater than X, the channel bandwidth allocation apparatus 700 may set a current value as the number of minislots of the available channel and otherwise, the channel bandwidth allocation apparatus 700 may set a previous value as the number of minislots.

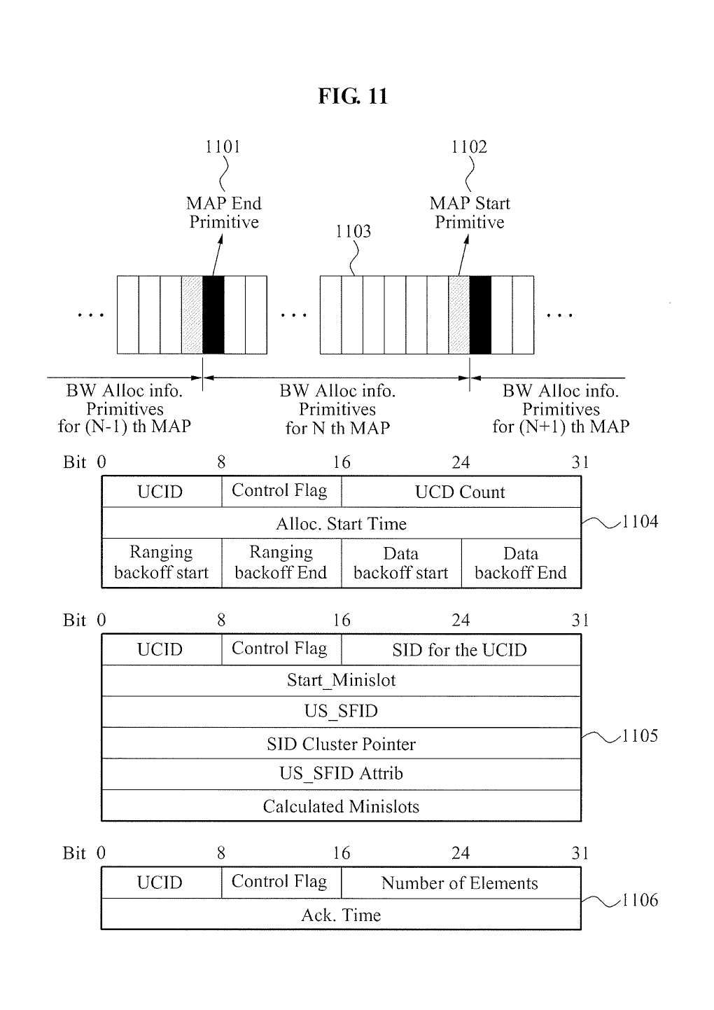

FIG. 11 is a diagram illustrating an example of an output format of a bandwidth allocation request information packet for each allocated channel according to an embodiment of the present invention.

As shown in FIG. 11, during a bandwidth allocation request processing process, when a number of minislots allocated for each of upstream channels is greater than a number of minislots that may be allocated for each MAP message, a MAP end primitive 1101 or 1106 and a MAP start primitive 1102 or 1104 may be output. Here, the MAP end primitive 1101 or 1106 may be a message informing about an end of a bandwidth allocation for a single MAP message. The MAP start primitive 1102 or 1104 may be a message informing about a start of the bandwidth allocation for a new MAP message.

The MAP start primitive 1102 or 1104, the MAP end primitive 1101 or 1106, and a primitive 1103 or 1105 that is a message informing the bandwidth allocation may be finally output to a bandwidth allocation request information processor. Here, the above messages may be classified based on a control flag of a second byte.

FIG. 12 is a block diagram illustrating a configuration of a per-channel MAP message generator 1200 according to an embodiment of the present invention.

The same message as an output form of per-channel bandwidth allocation request information shown in FIG. 11 may be output. A MAP message may be generated using a bandwidth allocation request information processor 1210 and a MAP message generator 1220.

Specifically, the per-channel MAP message generator 1200 may further include the bandwidth allocation request information processor 1210 and the MAP message generator 1220. The bandwidth allocation request information processor 1210 may generate an interval element (IF) regarding the bandwidth allocation request information that is processed for each channel and is stored in a queue by a minislot allocation unit (not shown), and may store the IE in an IE table. The MAP message generator 1220 may generate and output a MAP message associated with at least one channel by referring to the IE table.

The MAP message generator 1220 may classify the minislot based on the bandwidth allocation request information to construct a separate table.

Specifically, the per-channel MAP message generator 1200 may generate an IE, included in a DOCSIS MAP message, with respect to a bandwidth allocation request information primitive that is processed for each channel and is stored in a queue, and store the generated IE in the IE table. The per-channel MAP message generator 1200 may generate and output a MAP message from the IE table.

Also, the bandwidth allocation request information processor 1210 may classify bandwidth allocation request information into valid bandwidth allocation request information where a minislot excluding “0” is allocated, and non-valid bandwidth allocation request information where no minislot is allocated, for example, null/grant pending/ACK.

The valid bandwidth allocation request information may be simultaneously output to a valid IE table and a valid bandwidth allocation request information primitive buffer of an upstream burst data reception block of each upstream channel. The non-valid information may be stored only in a non-valid IE table.

Also, each entry of the valid IE table may be stored in a form of SID, IUC, and offset. Each value may be set as follows:

For example, SID denotes input valid bandwidth allocation request information. SID and IUC correspond to IUC of the input valid bandwidth allocation request information primitive. Offset may indicate a difference between “minislot start” of a corresponding bandwidth allocation request information primitive and “alloc start time” included in a MAP start primitive.

Bandwidth allocation request information that is converted and is output to a block performing an upstream burst data reception function may be information that is output by adding a minislot size, an upstream channel ID, and a UCD count to existing bandwidth allocation request information.

The non-valid bandwidth allocation request information may be converted and be stored in an entry of the non-valid IE table. Each entry of the non-valid IE table may be stored in a form of SID and IUC. Also, parameters associated with the MAP start primitive and a MAP end primitive with respect to a MAP message may be updated and be stored in a MAP parameter table.

Also, when Complete_MAP and MAP_period are activated with respect to an output indication signal and a single MAP message, the MAP message generator 1220 may generate and output a single MAP message.

According to an embodiment of the present invention, a plurality of cable modems may share a plurality of upstream channels to effectively transmit data.

Also, according to an embodiment of the present invention, it is possible to provide a high speed upstream data transmission service.

Also, according to an embodiment of the present invention, a CMTS may allocate a real-time processing upstream bandwidth using an upstream channel transmission form defined in a DOCSIS 3.0 standard.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for a channel bandwidth allocation, the apparatus comprising:
an information sorting unit to receive bandwidth allocation request information, to sort the received bandwidth allocation request information according to a priority, and to transfer any one of the sorted bandwidth allocation request information to a minislot allocation unit; and
a calculation unit to apply a multiplier to a number of bytes, and to transfer, to the minislot allocation unit, the bandwidth allocation request information where a number of requested bytes is calculated, when the bandwidth allocation request information is byte-based bandwidth allocation request information,
wherein the minislot allocation unit allocates a minislot based on the bandwidth allocation request information and predetermined setting information.

2. The apparatus of claim 1, wherein the channel bandwidth allocation apparatus is performed based on a Data-over-Cable Service Interface Specification (DOCSIS) 3.0 standard.

3. The apparatus of claim 1, wherein the information sorting unit multiplexes the sorted bandwidth allocation request information to transfer any one of the multiplexed bandwidth allocation request information to the minislot allocation unit.

4. The apparatus of claim 1, wherein the bandwidth allocation request information received by the information sorting unit includes at least one of unicast ranging information, information generated in a request frame form of a contention interval, information input in a piggyback form of a non-segment service flow, information input in a piggyback form of a segment service flow, and reserved information.

5. The apparatus of claim 4, further comprising:
a contention interval decision unit to receive form recognition information from the information sorting unit, and to transfer the form recognition information to the minislot allocation unit, when the output bandwidth allocation request information is in the request frame form of the contention interval.

6. The apparatus of claim 1, further comprising:
a setting unit to set the setting information as a real-time bandwidth allocation parameter that is calculated based on user command information and at least one Upstream Channel Description (UCD) information parameter for each upstream channel.

7. The apparatus of claim 6, wherein the setting unit comprises:
a UCD processor to receive the user command information and the at least one UCD information parameter for each upstream channel;
a downstream frame processor to output per-channel UCD information that is generated based on the user command information and the at least one UCD information parameter; and
an upstream frame processor to calculate the at least one UCD information parameter using a real-time bandwidth allocation available parameter, and to set the setting information using the calculated parameter.

8. The apparatus of claim 7, wherein:
the upstream frame processor stores, in a storage unit, a minislot table that is calculated based on a maximum burst size for each channel, and
the minislot allocation unit allocates the minislot by referring to the minislot table.

9. The apparatus of claim 8, further comprising:
a bandwidth allocation request information processor to generate an interval element (IE) regarding the bandwidth allocation request information that is processed for each channel and is stored in a queue by the minislot allocation unit, and to store the IE in an IE table; and
a MAP message generator to generate and output a MAP message associated with at least one channel by referring to the IE table.

10. The apparatus of claim 9, wherein the MAP message generator classifies the minislot based on the bandwidth allocation request information to construct a separate table.

11. A method for a channel bandwidth allocation, the method comprising:
receiving bandwidth allocation request information to sort the received bandwidth allocation request information according to a priority, and to transfer any one of the sorted bandwidth allocation request information to a minislot allocation unit;
applying a multiplier to a number of bytes to transfer, to the minislot allocation unit, the bandwidth allocation request information where a number of requested bytes is calculated, when the bandwidth allocation request information is byte-based bandwidth allocation request information; and
allocating a minislot based on the bandwidth allocation request information and predetermined setting information.

12. The method of claim 11, wherein the setting information is a real-time bandwidth allocation parameter that is calculated based on user command information and at least one UCD information parameter for each upstream channel.

13. A method for a channel bandwidth allocation, the method comprising:
determining whether a period is a MAP output period;
determining whether another bandwidth allocation request information is received, when the period is not the MAP output period;
applying a multiplier to a number of bytes to output the other bandwidth allocation request information where a number of requested bytes is calculated, when the other bandwidth allocation request information is received;
determining whether a minislot length of a minislot allocated by a previous Interval Usage Code (IUC) allocation scheme exceeds an IUC period in at least one upstream channel;
allocating and outputting an IUC interval with respect to a channel where the minislot length exceeds the IUC period;
determining whether a number of minislots exceeds a number of minislots that can be allocated per a single MAP message in the at least one upstream channel;
outputting a MAP end primitive about the MAP message exceeding the number of minislots, and outputting a MAP start primitive about another MAP message, when the number of minislots exceeds the number of minislots that can be allocated per the single MAP message; and
outputting contention interval bandwidth allocation request interval information when the primitives are output.

14. The method of claim 13, further comprising:
generating and outputting the MAP message by referring to a minislot table, when it is the MAP output period; and
outputting the bandwidth allocation request information where a service ID (SID) of an unused interval is allocated, when a bandwidth allocated for the at least one channel disuses an interval about a MAP length.

15. The method of claim 13, wherein the applying and the outputting comprises:
normalizing and comparing minislot values of allocated minislots in the at least one channel;
comparing the normalized minislot values;
allocating a first allocation bandwidth to an available channel between an early point in time and a late point in time;
allocating a second allocation bandwidth to an additionally available channel within a service flow transmitting the bandwidth allocation request information, when the first allocation bandwidth is less than a number of bytes requested by a cable modem; and
adjusting the first allocation bandwidth and the second allocation bandwidth, when the first allocation bandwidth and the second allocation bandwidth are inseparable with respect to a required bandwidth.

16. The method of claim 15, wherein the allocating of the first allocation bandwidth is performed according to the following Equation 1 and Equation 2:
NCMT(n)=CMT(n)×2^{M(n)}, M(n)=0, . . . , 7 diff_{—}NCMT(n)=max_{—}CMT−NCMT(n), [Equation 1]
where CMT(n) denotes a currently allocated minislot value with respect to an available upstream channel n, NCMT(n) denotes a normalized minislot value with respect to CMT(n), max_NCMT denotes a maximum value among the normalized minislot values, diff_NCMT(n) denotes a difference with the maximum value, n denotes a transmittable upstream channel, and M(n) denotes a minislot size in the upstream channel n, and
$$alloc\_mslot ( n ) = \frac{diff\_NCMT ( n )}{{2}^{M ( n )}} \\ alloc\_bytes ( n ) = byte\_lookup ( n , alloc\_mslot ( n ) ) \\ alloc\_bytes \_sum = {\sum }_{AvailableChannels} byte\_lookup ( n , alloc\_byte ( n ) ) , \qquad [ Equation 2 ]$$
where alloc_mslot(n) denotes a number of minislots allocated with respect to transmittable upstream channels according to a request for byte-based bandwidth allocation request information, alloc_byte(n) denotes a number of bytes that are transmittable to each allocated minislot of each channel, alloc_bytes_sum denotes a total number of bytes, and byte_lookup(n, s) denotes a number of bytes that are transmittable to s minislots with respect to the upstream channel n.

17. The method of claim 16, further comprising:
reallocating the first allocation bandwidth according to the following Equation 3, when a number of bytes transmittable to a minislot allocated for the first allocation bandwidth is greater than a number of bytes requested for a bandwidth allocation:
$$K = \frac{alloc\_bytes \_sum}{X} \\ min\_offset \_CMT = \frac{max\_NCMT - min\_NCMT}{K} \\ upper\_NCMT = min\_NCMT + min\_offset \_NCMT \\ alloc\_mslot ( n ) = \frac{upper\_NCMT - NCMT ( n )}{{2}^{M ( n )}} \qquad [ Equation 3 ]$$
where min_NCMT denotes a minimum value among the normalized minislot values, upper_NCMT denotes an upper reference value with respect to the normalized minislot values, X denotes a number of bytes required for the bandwidth allocation, and basic_bytes_a_set denotes a number of bytes that are transmittable using the minislot in the transmittable channel.

18. The method of claim 16, wherein the allocating of the second allocation bandwidth comprises:
selecting any one channel from available channels to calculate a relative data transmission rate with respect to the selected channel;
calculating a number of first additional minislots with respect to the selected channel and a number of bytes transmittable via the first additional minislots;
calculating a number of second additional minislots corresponding to the number of first additional minislots with respect to the available channels;
setting alloc_mslot(n) of the Equation 2 and the number of second additional minislots as alloc_mslot(n) using the normalized minislot values;
calculating alloc_bytes_sum using the Equation 2; and
additionally allocating a minislot of the second allocation bandwidth until alloc_bytes_sum becomes greater than X with respect to the available channels, when alloc_bytes_sum is less than X.

19. The method of claim 16, wherein the adjusting of the allocation bandwidth comprises:
calculating spare bytes that is a difference value between alloc_bytes_sum and X with respect to available channels;
decreasing the number of minislots corresponding to spare minislots, when alloc_bytes_sum is greater than a sum of X and a number of bytes that are transmittable using a single minislot in the available channel;
calculating alloc_bytes_sum by decreasing the number of minislots with respect to the available channels; and
setting a current value as the number of minislots of the available channels when alloc_bytes_sum is greater than X, and setting a previous value as the number of minislots when alloc_bytes_sum is less than X.
